(19) United States
(12) Patent Application Publication
(10) Pub. No.: US 2026/0128736 A1
(43) Pub. Date: May 7, 2026

(54) CLOCK GLITCH DETECTION CIRCUIT AND METHOD THEREOF

(71) Applicant: PUFsecurity CORPORATION, ZHUBEI CITY (TW)

(72) Inventors: CHI-YI SHAO, HSINCHU COUNTY (TW); SHENG-TSUNG WANG, HSINCHU COUNTY (TW); CHIH-NI WU, HSINCHU COUNTY (TW)

(21) Appl. No.: 19/373,729

(22) Filed: Oct. 30, 2025

Related U.S. Application Data
(60) Provisional application No. 63/715,647, filed on Nov. 4, 2024.

(51) Int. Cl. H03K 5/19; G01R 31/317; G06F 1/08

(52) U.S. Cl. CPC H03K 5/19; G01R 31/31727; G06F 1/08

(57) ABSTRACT

The present application discloses a clock glitch detection circuit including a clock generator, a counter, and a detection unit. The clock generator receives an input clock signal, and generates a reference clock signal having a frequency higher than that of the input clock signal when the input clock signal is at a first voltage. The counter counts a current accumulated number of cycles of the reference clock signal that occur while the input clock signal is at the first voltage. The detection unit calculates a difference between the previous and the current accumulated numbers after the input clock signal changes from the first voltage to a second voltage. The detection unit generates an alarm signal according to the difference between the previous and the current accumulated numbers and stores the current accumulated number as the previous accumulated number.

### TECHNICAL FIELD

The present disclosure relates to a glitch detection circuit, and more particularly, to a glitch detection circuit capable of detecting glitch in a clock signal.

### DISCUSSION OF THE BACKGROUND

The clock signal is a critical component in electronic circuits, serving as the timing reference that synchronizes operations across various elements within the system. The precise periodicity of the clock signal ensures that data is processed in a coordinated manner, thereby facilitating the seamless execution of complex computational tasks. Consequently, even minor deviations or distortions in the clock signal (i.e., glitches) can adversely affect the circuit performance. For example, the glitch can lead to erroneous data sampling, signal interference, and misalignment of the system's state, potentially causing malfunction or failure of the entire circuit. Therefore, it is crucial to detect the clock signal glitch and avoid the malfunction or failure of the system.

### SUMMARY

One aspect of the present disclosure provides a clock glitch detection circuit. The clock glitch detection circuit includes a clock generator, a counter, a detection unit, and a sequential control unit. The clock generator receives an input clock signal, and generates a first reference clock signal when the input clock signal is at a first voltage. A frequency of the reference clock signal is higher than a frequency of the input clock signal. The counter counts a current accumulated number of cycles of the reference clock signal that occur while the input clock signal is at the first voltage. The detection unit calculates a difference between a previous accumulated number and the current accumulated number after the input clock signal changes from the first voltage to a second voltage, and, after the difference between the previous accumulated number and the current accumulated number is updated, generate an alarm signal according to the difference between the previous accumulated number and the current accumulated number and store the current accumulated number as the previous accumulated number.

Another aspect of the present disclosure provides a method for detecting clock glitches of an input clock signal with a clock glitch detection circuit. The clock glitch detection circuit includes a clock generator, a counter, and a detection unit. The method includes generating, by the clock generator, a first reference clock when the input clock signal is at a first voltage, counting, by the counter, a first current accumulated number of cycles of the first reference clock signal that occur while the input clock signal is at the first voltage, calculating, by the detection unit, a difference between a first previous accumulated number and the first current accumulated number after the input clock signal changes from the first voltage to a second voltage, generating, by the detection unit, a first alarm signal according to the difference between the first previous accumulated number and the first current accumulated number after the difference between a first previous accumulated number and the first current accumulated number is updated, and storing, by the detection unit, the first current accumulated number as the first previous accumulated number. A frequency of the first reference clock signal is higher than a frequency of the input clock signal.

### BRIEF DESCRIPTION OF THE PLOTTINGS

A more complete understanding of the present disclosure may be derived by referring to the detailed description and claims when considered in connection with the Figures, where like reference numbers refer to similar elements throughout the Figures.

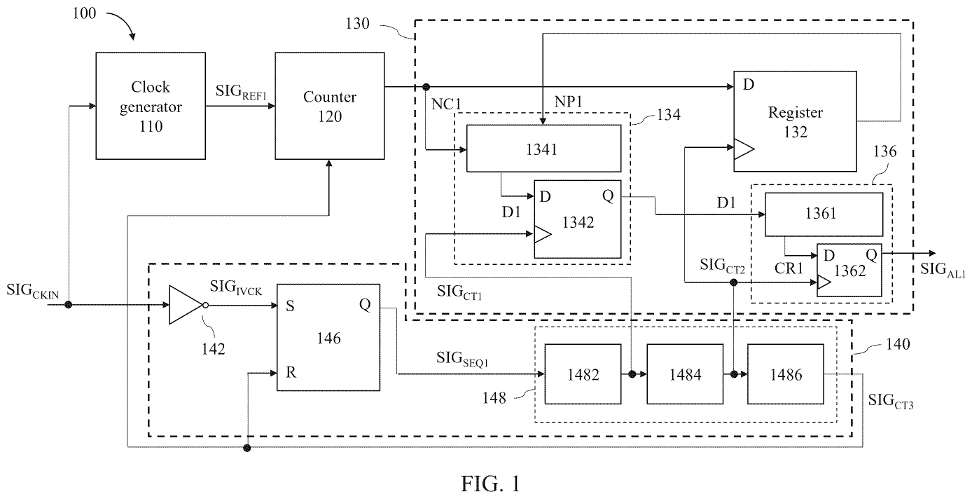

FIG. 1 shows a clock glitch detection circuit according to one embodiment of the present disclosure.

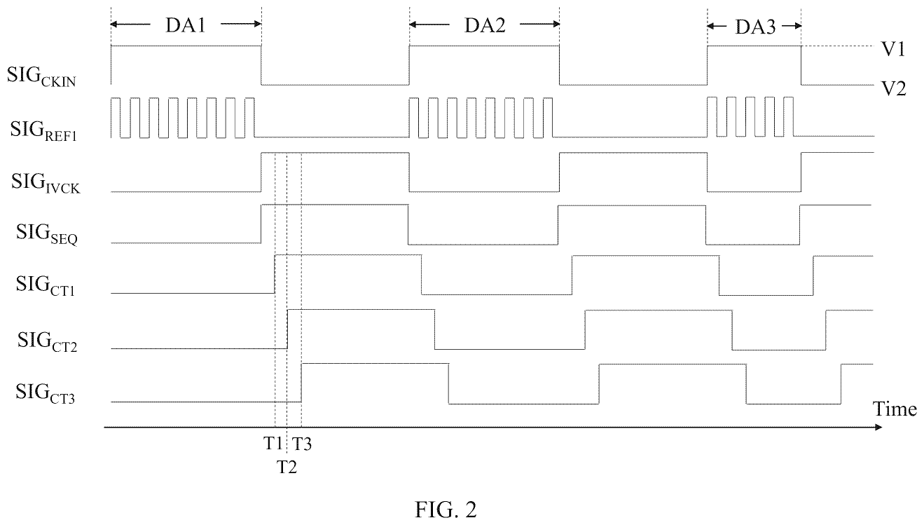

FIG. 2 shows a signal timing diagram of the clock glitch detection circuit in FIG. 1 according to one embodiment of the present disclosure.

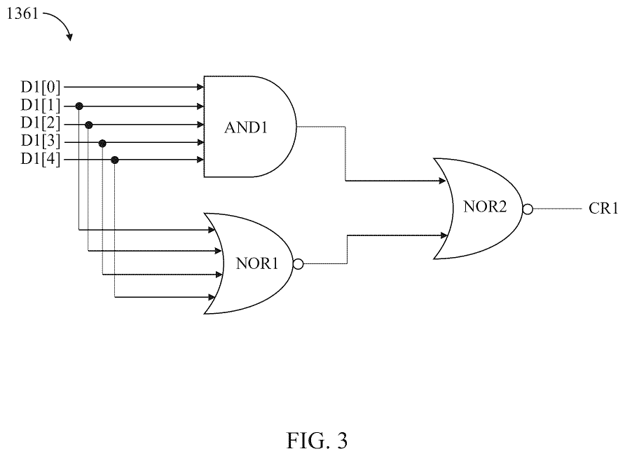

FIG. 3 shows the logic circuit according to one embodiment of the present disclosure.

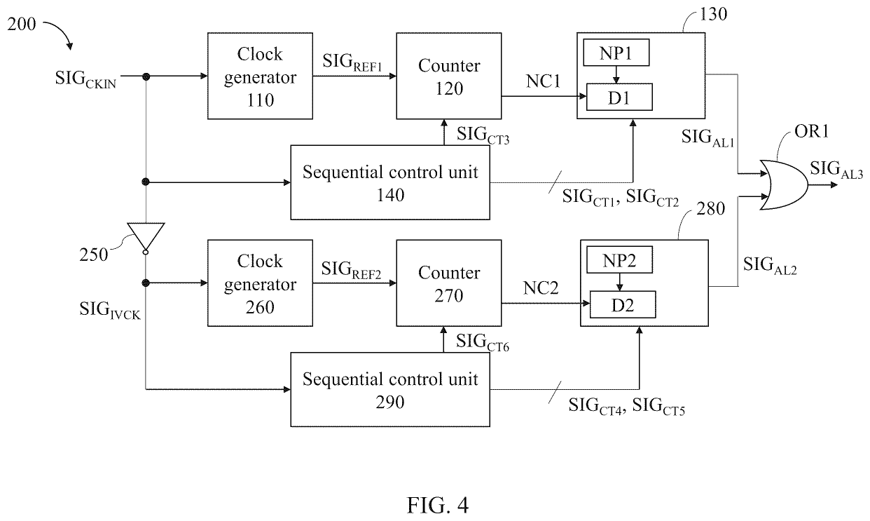

FIG. 4 shows a clock glitch detection circuit according to one embodiment of the present disclosure.

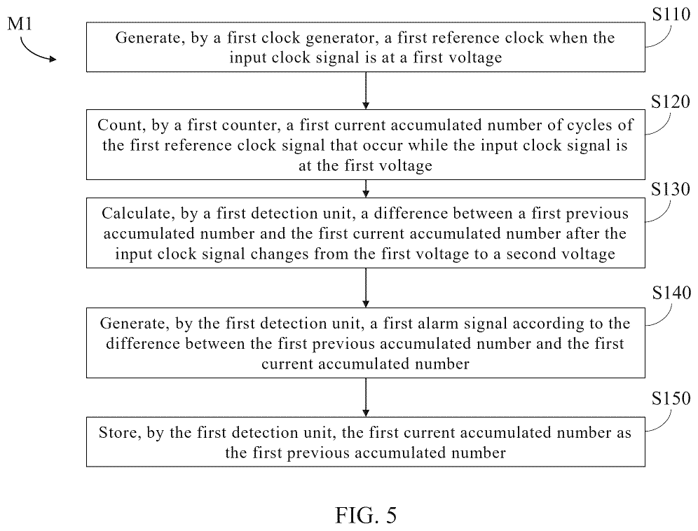

FIG. 5 shows a method for detecting clock glitches of the input clock signal according to one embodiment of the present disclosure.

### DETAILED DESCRIPTION

FIG. 1 shows a clock glitch detection circuit 100 according to one embodiment of the present disclosure. The clock glitch detection circuit 100 includes a clock generator 110, a counter 120, and a detection unit 130. In the present embodiment, the clock glitch detection circuit 100 is designed to detect glitches in an input clock signal SIG_{CKIN} that toggles between voltages V1 and V2.

The clock generator 110 can receive the input clock signal SIG_{CKIN}, generate a reference clock signal SIG_{REF1} when the input clock signal SIG_{CKIN} is at the voltage VI, and stop generating the reference clock signal SIG_{REF1} when the input clock signal SIG_{CKIN} is at the voltage V2. That is, the clock generator 110 can be enabled when the input clock signal SIG_{CKIN} is at the voltage V1, and can be disabled when the input clock signal SIG_{CKIN} is at the voltage V2. In the present embodiment, the voltage V1 can be higher than the voltage V2, however, the present disclosure is not limited thereto.

In the present embodiment, the reference clock signal SIG_{REF1} can have a frequency higher than a frequency of the input clock signal SIG_{CKIN}. The counter 120 can count a current accumulated number of cycles of the reference clock signal SIG_{REF1} that occur while the input clock signal SIG_{CKIN} is at the voltage V1 so as to measure the duration that the input clock signal SIG_{CKIN} is at the voltage V1. For example, the counter 120 may increment by one on each rising or falling edge of the reference clock signal SIG_{REF1}. In such case, a duration that the input clock signal SIG_{CKIN} remains at the voltage V1 can be measured by the counter 120 according to the number of cycles of the reference clock signal SIG_{REF1} that occur in such duration. In the present embodiment, since the voltage V1 is higher than the voltage V2, the duration that the input clock signal SIG_{CKIN} remains at the voltage V1 can also be referred to as the “on time” of the input clock signal SIG_{CKIN}, and the duration that the input clock signal SIG_{CKIN} remains at the voltage V2 can be referred to as the “off time” of the input clock signal SIG_{CKIN}.

Generally, if there's no glitch in the input clock signal SIG_{CKIN}, then a duration that the input clock signal SIG_{CKIN} remains at the voltage V1 should be equal to a next duration that the input clock signal SIG_{CKIN} remains at the voltage V1, that is, the subsequent on times should have the same lengths. However, if there's a glitch in the input clock signal SIG_{CKIN}, then the two subsequent durations that the input clock signal SIG_{CKIN} remains at the voltage V1 may be different, that is, the subsequent on times should have different lengths. Therefore, by comparing the lengths of the two subsequent durations that the input clock signal SIG_{CKIN} remains at the voltage V1 (i.e., the lengths of the two subsequent on times), the glitch occurs in such durations can be detected.

FIG. 2 shows a signal timing diagram of the clock glitch detection circuit 100 according to one embodiment of the present disclosure. As shown in FIG. 2, during the duration DA1 of the input clock signal SIG_{CKIN}, eight cycles of the reference signal clock SIG_{REF1} has passed, and during the next duration DA2 of the input clock signal SIG_{CKIN}, there are also eight cycles of the reference signal clock SIG_{REF1} passing, which indicates that the lengths of the two durations DA1 and DA2 are substantially equal, and thus, it may imply that there's not glitch in the input clock signal SIG_{CKIN}.

However, during the duration DA2 of the input clock signal SIG_{CKIN}, eight cycles of the reference signal clock SIG_{REF1} have passed, and during the next duration DA3 of the input clock signal SIG_{CKIN}, only five cycles of the reference signal clock SIG_{REF1} have passed, which indicates that the lengths of the two duration are different, and thus, it may imply that there's a glitch in the input clock signal SIG_{CKIN}.

In the present embodiment, when the input clock signal SIG_{CKIN} remains at the voltage V1, the counter 120 may keep counting the cycles of the reference clock signal SIG_{REF1} (i.e., the current accumulated number NC1) so as to measure the duration of the current on time of the input clock signal SIG_{CKIN}. Subsequently, after the input clock signal SIG_{CKIN} changes from the voltage V1 to the voltage V2 (i.e., changing from the on time to the off time), the detection unit 130 can calculate the difference D1 between the current accumulated number NC1 obtained by the counter 120 and the previous accumulated number NP1 stored in the register 132.

Afterwards, the detection unit 130 can further generate an alarm signal SIG_{AL1} according to the difference D1 between the current accumulated number NC1 and the previous accumulated number NP1, and store the current accumulated number NC1 to the register 132 as the previous accumulated number NP1 for the next detection.

For example, if the difference D1 between the current accumulated number NC1 and the previous accumulated number NP1 is greater than a predetermined value, for example, 1 or 2, then the detection unit 130 may determine that a glitch has occurred, and would generate the alarm signal SIG_{AL1} accordingly. However, if the difference D1 between the current accumulated number NC1 and the previous accumulated number NP1 is not greater than the predetermined value, then the detection unit 130 may determine that there's no glitch in the input clock signal SIG_{CKIN}, and would not generate the alarm signal SIG_{AL1}.

In some embodiments, the predetermined value used for determining the occurrence of glitches may be related to the ratio between the frequency of the input clock signal SIG_{CKIN} and the frequency of the reference clock signal SIG_{REF1}, and may also be related to the tolerance of the system. For example, in some cases if the frequency of the reference clock signal SIG_{REF1} is much higher than the input clock signal SIG_{CKIN}, then the difference of one or two cycles may be insignificant, and thus, the detection unit 130 may determines that there is no glitch. Also, in some cases, if the requirement for the accuracy of the clock signal is rather strict, then the predetermined value may be relatively small so as to detect the glitch in a more sensitive way. Therefore, the predetermined value can be designated according to the need.

In some embodiments, to control the operation sequence of the detection unit 130, the clock glitch detection circuit 100 may further include a sequential control unit 140 for generating control signals so as to trigger the detection unit 130 to perform corresponding operations. For example, as shown in FIG. 1 and FIG. 2, the sequential control unit 140 can generate a sequential control signal SIG_{SEQ1} when the input clock signal SIG_{CKIN} changes from the voltage V1 to the voltage V2. Also, the sequential control unit 140 can further generate a first control signal SIG_{CT1} by delaying the sequential control signal SIG_{SEQ1}, and the first detection unit 130 can be triggered to update the difference D1 between the current accumulated number NC1 and the previous accumulated number NP1 when receiving the first control signal SIG_{CT1} at time point T1 within the off time of the input clock signal SIG_{CKIN} shown in FIG. 2.

In addition, the sequential control unit 140 can generate a second control signal SIG_{CT2} by delaying the first control signal SIG_{CT1}, and the detection unit 130 can be triggered to generate the first alarm signal SIG_{AL1} (if a glitch is detected) and store the current accumulated number NC1 as the previous accumulated number NP1 for the next detection when receiving the second control signal SIG_{CT2} at the time point T2 within the off time of the input clock signal SIG_{CKIN} shown in FIG. 2.

Furthermore, in the present embodiment, the sequential control unit 140 can generate a third control signal SIG_{CT3} by delaying the second control signal SIG_{CT2}, and the counter 120 can be reset when receiving the third control signal SIG_{CT3} at time point T3 within the off time of the input clock signal SIG_{CKIN} shown in FIG. 2.

That is, the sequential control unit 140 can generate the control signals SIG_{CT1}, SIG_{CT2}, and SIG_{CT3} according to the input clock signal SIG_{CKIN} so as to control the operation sequence of the detection unit 130 and the counter 120. As shown in FIG. 2, the pulses of the control signals SIG_{CT1} SIG_{CT2}, and SIG_{CT3} can be issued sequentially at time points T1, T2, and T3, and the judgement for the glitch can be completed within the duration that the input clock signal SIG_{CKIN} is at the voltage V2 (i.e., within the off time of the input clock signal SIG_{CKIN}). Therefore, the on time of the input clock signal SIG_{CKIN} can be deemed as a counting phase that allows the counter 120 to count the accumulated number of the cycles of the reference clock signal SIG_{REF1}, and the off time of the input clock signal SIG_{CKIN} can be deemed as a judging phase that allows the detection unit 130 to detect the glitch according to the counting result performed in the counting phase and prepare for the next detection.

In the present embodiment shown in FIG. 1, the sequential control unit 140 can include an inverter 142, an SR latch 146, and a delay control unit 148. The inverter 142 can generate an inversed input clock signal SIG_{IVCK} by inversing the input clock signal SIG_{CKIN}. The SR latch 146 includes a set terminal S for receiving the inversed input clock signal SIG_{IVCK}, a reset terminal R for receiving the third control signal SIG_{CT3}, a data output terminal Q for outputting the sequential control signal SIG_{SEQ1}. In some embodiments, the SR latch 146 can be implemented by two cross-coupled NOR gates. However, the present disclosure is not limited thereto. In some embodiments, the inverters 142 and the SR latch 146 can be combined and implemented as a negative edge trigger SR latch.

The delay control unit 148 can generate the first control signal SIG_{CT1}, the second control signal SIG_{CT2}, and the third control signal SIG_{CT3} according to the sequential control signal SIG_{SEQ1}. In some embodiments, the delay control unit 148 may include three delay elements 1482, 1484, and 1486, each of the delay elements 1482, 1484, and 1486 can generate an output by delaying its input. In some embodiments, the delay elements may include two cascaded inverters; however, the present disclosure is not limited thereto.

The detection unit 130 includes a register 132, a subtractor 134, and a compare logic circuit 136. Within the off time of the input clock signal SIG_{CKIN}, the subtractor 134 can subtract the previous accumulated number NP1 stored in the register 132 from the current accumulated number NC1 obtained by the counter 120 or subtract the current accumulated number NC1 from the previous accumulated number NP1 so as to calculate the difference D1 between the current accumulated number NC1 and the previous accumulated number NP1. In some embodiments, the subtractor 134 may include a carry look ahead subtractor 1341 and a register 1342, and the register 1342 in the subtractor 134 can be a flip-flop having a data input terminal D, a data output terminal Q, and an edge trigger terminal. In such case, the carry look ahead subtractor 1341 can be a combinational circuit that can continuously perform a subtract operation upon the current accumulated number NC1 and the previous accumulated number NP1, and keep updating the calculation result of the subtraction. In addition, the register 1342 in the subtractor 134 may be triggered by the first control signal SIG_{CT1}. That is, the difference D1 between the current accumulated number NC1 and the previous accumulated number NP1 can be stored to the register 1342 upon a rising edge of the first control signal SIG_{CT1}. In some embodiments, to ensure the correctness of the calculation result, the delay between the sequential control signal SIG_{SEQ1} and the first control signal SIG_{CT1} should be at least longer than the updating time required by the calculation of the subtractor 134, thereby allowing the subtractor 134 to finish the subtraction.

Subsequently, also within the off time of the input clock signal SIG_{CKIN}, when the register 132 receives the second control signal SIG_{CT2}, the register 132 can store the currently accumulated number NC1 as the previous accumulated number NP1 (i.e., updating the previous accumulated number for the next detection). In addition, upon receiving the second control signal SIG_{CT2}, the compare logic circuit 136 can check if the difference D1 between the current accumulated number NC1 and the previous accumulated number NP1 is greater than the predetermined value, and can generate the alarm signal SIG_{AL1} within the off time of the input clock signal SIG_{CKIN} when the difference D1 is greater than the predetermined value (i.e., a glitch is detected). In some embodiments, the compare logic circuit 136 may include a logic circuit 1361 and a register 1362, and the register 1362 in the compare logic circuit 136 can be a flip-flop. In such case, the logic circuit 1361 can be a combinational circuit that can continuously obtain a comparison result CR1 between the difference D1 calculated by the subtractor 134 and the predetermined value. In such case, the register 1362 can be triggered by the second control signal SIG_{CT2}. That is, the comparison result CR1 between the difference D1 and the predetermined value can be stored to the register 1362 upon a rising edge of the second control signal SIG_{CT2}. As a result, the register 1362 may output the alarm signal SIG_{AL1} according to the comparison result CR1. In some embodiments, to ensure the correctness of the comparison result, the delay between the first control signal SIG_{CT1} and the second control signal SIG_{CT2} should be at least longer than a calculating time of the compare logic circuit 136, thereby allowing the compare logic circuit 136 to finish the comparison.

With the registers 132, 1342, and 1362, the operations performed by the detection unit 130 can be controlled sequentially and specifically by the control signals SIG_{CT1} and SIG_{CT2}, thereby ensuring the correctness of the identification of the glitch.

In some embodiments, instead of storing the predetermined value with a register and comparing the difference DI with the predetermined value bit by bit, the logic circuit 1361 of the compare logic circuit 136 may be simplified by utilizing few logic gates. FIG. 3 shows the logic circuit 1361 according to one embodiment of the present disclosure. In the embodiment shown in FIG. 3, the difference D1 is represented in 2's complement with 5 bits, and the predetermined value is 1. Therefore, the logic circuit 1361 of the compare logic circuit 136 may output the alarm signal SIG_{AL1} when the difference D1 is not equal to “5′b00001” (i.e., “1” in decimal), “5′b00000” (i.e., “0” in decimal), or “5′b11111” (i.e., “31” in decimal and “−1” in 2's complement). In other words, when the difference D1 in decimal is not equal to “0”, “1”, or “31”, the difference D1 is greater than the predetermined value, and the compare logic circuit 136 may output the alarm signal SIG_{AL1}. In such case, according to the truth table of the logic circuit 1361, two NOR gates NOR1 and NOR2 and one AND gate AND1 can be adopted to implement the logic circuit 1361. Specifically, the AND gate AND1 may receive the five bits D1[0], D1[1], D1[2], D1[3], and D1[4] of the difference D1 as its inputs, the NOR gate NOR1 may receive the four most significant bits D1[1], D1[2], D1[3], and D1[4] of the difference D1 as its inputs, and the NOR gate NOR2 may receive the output of the AND gate AND1 and the output of the NOR gate NOR1 as its input. As a result, the NOR gate NOR2 is able to output the comparison result CR1 accordingly.

It should be noted that the structure of the clock glitch detection circuit 100 shown in FIG. 1 is for illustrative purposes and are not intended to limit the present disclosure. For example, in some embodiments, different structures may be adopted to implement the detection unit 130 and the sequential control unit 140.

In the present embodiment, the clock glitch detection circuit 100 can detect if there is a glitch in the two subsequent on times. However, the present disclosure is not limited thereto. In some embodiment, the glitch may occur in the durations that the input clock signal SIG_{CKIN} is at the voltage V2 (i.e., two subsequent off times), and the clock glitch detector 100 can be adopted to detect glitches occur in the off times of the input clock signal SIG_{CKIN} by inverting the input clock signal SIG_{CKIN} and use the inversed input clock signal SIG_{IVCK} as its input signal. In addition, in some embodiments, to detect glitches occur in both the on times and the off times of the input clock signal SIG_{CKIN}, the components shown in the glitch detection circuit 100 can be duplicated with its input being an inversed version of the input clock signal SIG_{CKIN}.

FIG. 4 shows a clock glitch detection circuit 200 according to one embodiment of the present disclosure. The clock glitch detection circuit 200 is different from the clock glitch detection circuit 100 in that the clock glitch detection circuit 200 further includes an inverter 250, a clock generator 260, a counter 270, a detection unit 280, and a sequential control unit 290.

In the present embodiment, while the clock generator 110, the counter 120, the detection unit 130, and the sequential control unit 140 are adopted to detect the glitches in the on times of the input clock signal SIG_{CKIN}, the inverter 250, the clock generator 260, the counter 270, the detection unit 280, and the sequential control unit 290 can be adopted to detect the glitches in the off times of the input clock signal SIG_{CKIN}.

Specifically, the inverter 250 can generate the inversed input clock signal SIG_{IVCK} by inversing the input clock signal SIG_{CKIN}. The clock generator 260 can receive the inversed input clock signal SIG_{IVCK}, and generate a reference clock signal SIG_{REF2} when the inversed input clock signal SIG_{IVCK} is at the voltage V1 with the frequency of the reference clock signal SIG_{REF2} higher than the frequency of the inversed input clock signal SIG_{IVCK}. In such case, the counter 270 can count a current accumulated number NC2 of cycles of the reference clock signal SIG_{REF2} that occur while the inversed input clock signal SIG_{IVCK} is at the voltage V1. That is, the reference clock signal SIG_{REF2} can be used as reference for measuring the duration of the off time of the input clock signal SIG_{CKIN} (i.e., the duration that the inversed input clock signal SIG_{IVCK} remains at the voltage V1).

In addition, the detection unit 280 can calculate a difference D2 between a previous accumulated number NP2 and the current accumulated number NC2 counted by the counter 270 after the inversed input clock signal SIG_{IVCK} changes from the voltage V1 to the voltage V2. After the difference D2 between the previous accumulated number NP2 and the current accumulated number NC2 is updated, the detection unit 280 can determine if there's any glitch during the subsequent on times of the inversed input clock signal SIG_{IVCK} (i.e., the subsequent off times of the input clock signal SIG_{CKIN}) according to the difference D2 and generate an alarm signal SIG_{AL2} if a glitch is detected. Also, the detection unit 280 can further store the current accumulated number NC2 as the previous accumulated number NP2 for the next detection. In some embodiments, the detection unit 280 can have the same structure as the detection unit 130 shown in FIG. 1.

In the present embodiment, the sequential control unit 290 can generate control signals for controlling the operation sequence of the detection unit 280. In some embodiments, the sequential control unit 290 can have a same structure as the sequential control unit 140 as shown in FIG. 1. For example, the sequential control unit 290 can generate a sequential control signal when the inversed input clock signal SIG_{IVCK} changes from the voltage V1 to the voltage V2, and generate the control signal SIG_{CT4} by delaying the sequential control signal. In such case, the detection unit 280 can be triggered to update the difference D2 between the previous accumulated number NP2 and the current accumulated number NC2 according to the control signal SIG_{CT4}.

Furthermore, the sequential control unit 290 can generate the control signal SIG_{CT5} by delaying the control signal SIG_{CT4}, and the detection unit 280 can be triggered to generate the alarm signal SIG_{AL2} (if a glitch is detected) and store the current accumulated number NC2 as the previous accumulated number NP2 according to the control signal SIG_{CT5}. In addition, the sequential control unit 290 can generate the control signal SIG_{CT6} by delaying the control signal SIG_{CT5}, and the counter 270 can be reset when receiving the control signal SIG_{CT6}.

In addition, in the present embodiment, the clock glitch detection circuit 200 may further include an OR gate OR1 with its two input terminals coupled to the output of the detection units 130 and 280. In such case, the clock glitch detection circuit 200 is able to output an alarm signal SIG_{AL3} through the output terminal of the OR gate OR1 either when the alarm signal SIG_{AL1} is issued by the detection unit 130 or when the alarm signal SIG_{AL2} is issued by the detection unit 280.

FIG. 5 shows a method M1 for detecting clock glitches of the input clock signal SIG_{CKIN} according to one embodiment of the present disclosure. The method MI includes steps S110 to S150. In some embodiments, the method M1 can be performed with the clock glitch detection circuit 100 or 200. For example, in step S110, the clock generator 110 can generate the reference clock SIG_{REF1} when the input clock signal SIG_{CKIN} is at the voltage V1 with the frequency of the reference clock signal SIG_{REF1} higher than the frequency of the input clock signal SIG_{CKIN}.

In step S120, the counter 120 can count the current accumulated number NC1 of cycles of the reference clock signal SIG_{REF1} that occur while the input clock signal SIG_{CKIN} is at the voltage V1 so as to measure the duration that the input clock signal SIG_{CKIN} remains at the voltage V1. In step S130, the detection unit 130 can calculate the difference D1 between the previous accumulated number NP1 and the current accumulated number NC1 after the input clock signal SIG_{CKIN} changes from the voltage V1 to the voltage V2. Subsequently, within the off time of the input clock signal SIG_{CKIN}, after the difference D1 between the previous accumulated number NP1 and the current accumulated number NC1 is updated, the detection unit 130 can detect if there's any glitch according to the difference D1 between the previous accumulated number NP1 and the current accumulated number NC1 and generate the alarm signal SIG_{AL1} when a glitch is detected in step S140. Also, in step S150, the detection unit 130 can store the current accumulated number NC1 as the previous accumulated number NP1 so as to prepare for the next detection.

In some embodiment, to control the operation sequence of the detection unit 130, the method M1 may further include having the sequential control unit 140 generate the sequential control signal SIG_{SEQ1} when the input clock signal SIG_{CKIN} changes from the voltage V1 to the voltage V2, and generate the control signals SIG_{CT1}, SIG_{CT2}, and SIG_{CT3} according to the sequential control signal SIG_{SEQ1}. Accordingly, the detection unit 130 can perform step S130 and update the difference D1 between the previous accumulated number NP1 and the current accumulated number NC1 when receiving the control signal SIG_{CT1}, and perform steps S140 and S150 when receiving the control signal SIG_{CT2}. Afterwards, the counter 120 can be reset when receiving the control signal SIG_{CT3}.

In the present embodiment, the method M1 can detect if there is a glitch in two subsequent on times. However, the present disclosure is not limited thereto. In some embodiment, the method M1 can also be adopted to detect glitches occur in the off times of the input clock signal SIG_{CKIN} by inverting the input clock signal SIG_{CKIN} and use the inversed input clock signal SIG_{IVCK} as its input signal to perform the steps S110 to S150.

In summary, the clock glitch detection circuit and the method for detecting clock glitches provided by the embodiments of the present disclosure can measure durations of two subsequent on times or off times of the input clock signal by a reference clock signal having a higher frequency and detect the glitches by observing if a difference between the two durations is greater than a predetermined value. The clock glitch detection circuit and the method for detecting clock glitches allow the user to detect the glitches with a desired tolerance by appropriately selecting the frequency of the reference clock signal and the predetermined value, and thus can be adopted in a variety of applications.

What is claimed is:

1. A clock glitch detection circuit comprising:
a first clock generator configured to receive an input clock signal, and generate a first reference clock signal when the input clock signal is at a first voltage, wherein a frequency of the first reference clock signal is higher than a frequency of the input clock signal;
a first counter configured to count a first current accumulated number of cycles of the first reference clock signal that occur while the input clock signal is at the first voltage in a counting phase; and
a first detection unit configured to calculate a difference between a first previous accumulated number and the first current accumulated number after the input clock signal changes from the first voltage to a second voltage in a judging phase later than the counting phase, and, after the difference between the first previous accumulated number and the first current accumulated number is calculated, store the first current accumulated number as the first previous accumulated number and generate a first alarm signal according to the difference between the first previous accumulated number and the first current accumulated number.

2. The clock glitch detection circuit of claim 1, further comprising:
a first sequential control unit configured to generate a first sequential control signal when the input clock signal changes from the first voltage to the second voltage, and generate a first control signal in the judging phase by delaying the first sequential control signal;
wherein the first detection unit is triggered to calculate the difference between the first previous accumulated number and the first current accumulated number according to the first control signal.

3. The clock glitch detection circuit of claim 2, wherein the first sequential control unit is further configured to generate a second control signal in the judging phase by delaying the first control signal;
wherein the first detection unit is triggered to generate the first alarm signal and store the first current accumulated number as the first previous accumulated number according to the second control signal.

4. The clock glitch detection circuit of claim 3, wherein the first sequential control unit is further configured to generate a third control signal in the judging phase by delaying the second control signal;
wherein the first counter is reset when receiving the third control signal.

5. The clock glitch detection circuit of claim 4, wherein the first sequential control unit comprises:
an SR latch comprising a set terminal configured to receive an inversed input clock signal, a reset terminal configured to receive the third control signal, and a data output terminal configured to output the first sequential control signal after the input clock signal changes to the second voltage; and
a delay control unit configured to generate the first control signal, the second control signal, and the third control signal according to the first sequential control signal.

6. The clock glitch detection circuit of claim 3, wherein the first detection unit comprises:
a register configured to store the first currently accumulated number as the first previous accumulated number when receiving the second control signal; and
a subtractor configured to subtract the first previous accumulated number from the first current accumulated number or subtract the first current accumulated number from the first previous accumulated number so as to calculate the difference between the first previous accumulated number and the first current accumulated number when receiving the first control signal.

7. The clock glitch detection circuit of claim 6, wherein a first delay between the first sequential control signal and the first control signal is longer than a calculating time of the subtractor.

8. The clock glitch detection circuit of claim 6, wherein the subtractor comprises:
a carry look ahead subtractor configured to continuously perform a subtract operation upon the first current accumulated number and the first previous accumulated number to calculate the difference between the first previous accumulated number and the first current accumulated number; and
a register configured to be triggered by the first control signal to store the difference between the first previous accumulated number and the first current accumulated number.

9. The clock glitch detection circuit of claim 6, wherein the first detection unit further comprises: a compare logic circuit configured to generate the first alarm signal in the judging phase when receiving the second control signal and when the difference between the first previous accumulated number and the first current accumulated number is greater than a predetermined value.

10. The clock glitch detection circuit of claim 9, wherein the compare logic circuit comprises:
a logic circuit configured to continuously obtain a comparison result between the difference calculated by the subtractor and the predetermined value; and
a register configured to be triggered by the second control signal to store the comparison result between the difference calculated by the subtractor and the predetermined value.

11. The clock glitch detection circuit of claim 9, a second delay between the first control signal and the second control signal is longer than a calculating time of the compare logic circuit.

12. The clock glitch detection circuit of claim 1, wherein the first detection unit generates the first alarm signal in the judging phase when the difference between the first previous accumulated number and the first current accumulated number is greater than a predetermined value.

13. The clock glitch detection circuit of claim 1, wherein the first clock generator is disabled when the input clock signal is at the second voltage.

14. The clock glitch detection circuit of claim 1, further comprising:
a third inverter configured to generate an inversed input clock signal by inversing the input clock signal;
a second clock generator configured to receive the inversed input clock signal, and generate a second reference clock signal when the inversed input clock signal is at the first voltage, wherein a frequency of the second reference clock signal is higher than a frequency of the inversed input clock signal;
a second counter configured to count a second current accumulated number of cycles of the second reference clock signal; and
a second detection unit configured to calculate a difference between a second previous accumulated number and the second current accumulated number after the inversed input clock signal changes from the first voltage to the second voltage, and, after the difference between the second previous accumulated number and the second current accumulated number is calculated, generate a second alarm signal according to the difference between the second previous accumulated number and the second current accumulated number and store the second current accumulated number as the second previous accumulated number.

15. The clock glitch detection circuit of claim 14, further comprising:
a second sequential control unit configured to generate a second sequential control signal when the inversed input clock signal changes from the first voltage to the second voltage, and generate a fourth control signal by delaying the second sequential control signal;
wherein the second detection unit is triggered to calculate the difference between the second previous accumulated number and the second current accumulated number according to the fourth control signal.

16. The clock glitch detection circuit of claim 15, wherein the second sequential control unit is further configured to generate a fifth control signal by delaying the fourth control signal and a sixth control signal by delaying the fifth control signal;
wherein the second detection unit is triggered to generate the second alarm signal and store the second current accumulated number as the second previous accumulated number according to the fifth control signal, and the second counter is reset when receiving the sixth control signal.

17. A method for detecting clock glitches of an input clock signal with a clock glitch detection circuit, wherein the clock glitch detection circuit comprises a first clock generator, a first counter, and a first detection unit, and the method comprises:
generating, by the first clock generator, a first reference clock signal when the input clock signal is at a first voltage, wherein a frequency of the first reference clock signal is higher than a frequency of the input clock signal;
counting, by the first counter, a first current accumulated number of cycles of the first reference clock signal;
calculating, by the first detection unit, a difference between a first previous accumulated number and the first current accumulated number after the input clock signal changes from the first voltage to a second voltage;
generating, by the first detection unit, a first alarm signal according to the difference between the first previous accumulated number and the first current accumulated number after the difference between a first previous accumulated number and the first current accumulated number is calculated; and
storing, by the first detection unit, the first current accumulated number as the first previous accumulated number after the difference is calculated.

18. The method of claim 17, wherein the clock glitch detection circuit further comprises a first sequential control unit, and the method further comprises:
generating, by the first sequential control unit, a first sequential control signal when the input clock signal changes from the first voltage to the second voltage; and
generating, by the first sequential control unit, a first control signal by delaying the first sequential control signal;
wherein the difference between the first previous accumulated number and the first current accumulated number is calculated when the first detection unit receives the first control signal.

19. The method of claim 18, further comprising:
generating, by the first sequential control unit, a second control signal by delaying the first control signal;
wherein the step of generating, by the first detection unit, the first alarm signal according to the difference between the first previous accumulated number and the first current accumulated number and the step of storing, by the first detection unit, the first current accumulated number as the first previous accumulated number are performed when the first detection unit receives the second control signal.

20. The method of claim 19, further comprising:
generating, by the sequential control unit, a third control signal by delaying the second control signal; and
resetting the first counter when receiving the third control signal.

21. The method of claim 17, wherein the step of generating, by the first detection unit, the first alarm signal according to the difference between the first previous accumulated number and the first current accumulated number comprises generating, by the first detection unit, the first alarm signal when the difference between the first previous accumulated number and the first current accumulated number is greater than a predetermined value.

22. The method of claim 17, wherein the clock glitch detection circuit further comprises an inverter, a second clock generator, a second counter, and a second detection unit, and the method further comprises:
generating, by the inverter, an inversed input clock signal by inversing the input clock signal;
generating, by the second clock generator, a second reference clock signal when the inversed input clock signal is at the first voltage, wherein a frequency of the second reference clock signal is higher than a frequency of the inversed input clock signal;
counting, by the second counter, a second current accumulated number of cycles of the second reference clock signal;
calculating, by the second detection unit, a difference between a second previous accumulated number and the second current accumulated number after the inversed input clock signal changes from the first voltage to the second voltage; and
generating, by the second detection unit, a second alarm signal according to the difference between the second previous accumulated number and the second current accumulated number after the difference between a second previous accumulated number and the second current accumulated number is calculated.

23. The method of claim 22, wherein the clock glitch detection circuit further comprises a second sequential control unit, and the method further comprises:
generating, by the second sequential control unit, a second sequential control signal when the inversed input clock signal changes from the first voltage to the second voltage;
generating, by the second sequential control unit, a fourth control signal by delaying the second sequential control signal;
generating, by the second sequential control unit, a fifth control signal by delaying the fourth control signal;
generating, by the second sequential control unit, a sixth control signal by delaying the fifth control signal; and
resetting the second counter when receiving the sixth control signal;
wherein:
the difference between the second previous accumulated number and the second current accumulated number is calculated when the second detection unit receives the fourth control signal; and
the step of generating, by the second detection unit, the second alarm signal according to the difference between the second previous accumulated number and the second current accumulated number and the step of storing, by the second detection unit, the second current accumulated number as the second previous accumulated number are performed when the second detection unit receives the fifth control signal.
